(19) United States
(12) Patent Application Publication
(10) Pub. No.: US 2014/0268382 A1
(43) Pub. Date: Sep. 18, 2014

(54) Clear Shot Mirror Mount

(71) Applicant: Billy G. Morris, Greer, SC (US)

(72) Inventor: Billy G. Morris, Greer, SC (US)

(21) Appl. No.: 14/090,286

(22) Filed: Feb. 18, 2014

Related U.S. Application Data
(60) Provisional application No. 61/732,540, filed on Dec. 3, 2012.

(51) Int. Cl. B60R 1/00

(52) U.S. Cl. CPC B60R 1/007
USPC 359/872

(57) ABSTRACT

Clear Shot Mirrors are side view mirrors that are unique because the angles of the mirror base where the mirror head mounts, as well as the angle of the mirror spacer plate under the base, are different. These angles are changed to maximize inward adjustability of each mirror head, eliminating the passenger side blind spot that exists in standard mirrors currently on the market.

### BACKGROUND OF THE INVENTION

Clear Shot Mirrors are a replacement for standard classic GM cars side view mirrors, and successfully solves the problem of the passenger side blind spot.

### BRIEF SUMMARY OF INVENTION

Clear Shot Mirrors eliminate the passenger side blind spot by modifying the angles of the mirror base. This allows for more inward adjustability of the mirror head, and allows the driver to have more visibility of the lane beside the car's passenger side.

### BRIEF DESCRIPTION OF THE SEVERAL VIEWS OF THE DRAWING

FIG. 1. This drawing depicts the side view of the Clear Shot Mirror's base with mirror head mounted, showing the angle change of the hole where the mirror head mounts to the mirror base.

FIG. 2. This drawing depicts the front view of the Clear Shot Mirror's base and the mirror head mounted to it.

FIG. 3. This drawing shows the bottom view of the Clear Shot Mirror's base.

FIG. 4. This drawing shows the top view of the Clear Shot Mirror's base.

FIG. 5. This drawing shows the Clear Shot Mirror's base from the side view, and notes that any change (denoted A°) to the angle of the mirror base off of parallel is included in this invention.

FIG. 6. This drawing shows the top view of the Clear Shot Mirror's spacer plate, which will be used under the mirror base.

FIG. 7. This drawing depicts the Clear Shot Mirror's spacer plate from the side view, clearly showing how it is angled.

### DETAILED DESCRIPTION OF THE INVENTION

Clear Shot Mirrors are made in a high-pressure die cast mold out of aluminum, tumbled and polished, then chrome plated. The mirror head and base are replacements for standard GM mirrors. The mirror base spacer plate is machined from UHMW plastic in a CNC lathe. The differences between Clear Shot Mirrors and standard mirrors are:
1. The Clear Shot Mirrors have an angle off of parallel to the mounting base, whether in the mirror head mounting hole and/or in the base itself (FIG. 5).
2. The Clear Shot Mirrors have an angled mirror spacer plate that allows further inward adjustability of the mirror head by setting the mirror base off of the parallel mounting surface (FIG. 7).
   To install Clear Shot Mirrors, the customer would mount the mirror spacer plate and a mounting tab (mounting tab is not part of invention) to the door of the car, which the mirror base would then attach to with another screw that is provided.

1. An article of invention for Clear Shot Mirrors include the mirror head, mirror base, spacer plate, and any angle change made to any or all of these parts to increase inward adjustability.
